(19) United States
(12) Patent Application Publication
(10) Pub. No.: US 2004/0121270 A1
(43) Pub. Date: Jun. 24, 2004

(54) Low volume drum processor

(75) Inventors: Gareth Evans, Hertfordshire (GB); Peter Hewitson, Uxbridge (GB); Leslie R. Wells, Bounds Green (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/325,999

(22) Filed: Dec. 18, 2002

(51) Int. Cl. G03C 7/407; G03D 5/06; G03D 13/08

(52) U.S. Cl. 430/403; 396/606; 430/373; 430/414; 430/418

(57) ABSTRACT

A method of processing material in which the material is held on the outside periphery of a drum and processing solution is applied at least twice to the sensitized surface of the material as the drum rotates. The total volume of solution applied is less than 300 ml/sqm of material being processed.

This is a U.S. original patent application which claims priority on Great Britain patent application No. 0130184.5 filed Dec. 18, 2001.

### FIELD OF THE INVENTION

This invention relates to the field of photographic processing, especially to processing that uses low volumes of processing solutions which are used only once and then discarded.

### BACKGROUND OF THE INVENTION

Photographic processors normally use tanks of solution through which photosensitive materials are passed. The processing solutions are modified as a result of processing. In order to achieve a consistent performance the modified solutions are replenished with solutions which differ in composition in a way which, in combination with the loss of solution by displacement with the replenisher solutions, allow an approximately constant composition to be maintained.

The assumptions used in calculating the amounts of replenisher solution needed are approximate. For example, since the exposure of this material varies the resulting chemical changes vary. The process has to be kept in control by repeated testing and intervention. In addition, tanks of processing solution open to the air are prone to deteriorate due to oxidation, acidification and evaporation. These factors are variable depending on ambient temperature and humidity. Thus a degree of process variability is inherent in the design of conventional processors.

Low-volume thin tank processors allow the tank solution to be replaced by replenishment in a shorter time but the residence time is still very much longer than the process time. For example, U.S. Pat. No. 5,387,499 describes a low volume thin tank design (LVTT). Also, U.S. Pat. No. 5,475,461 describes a low volume drum processor in which a drum is located within the tank, leaving a gap of less than 5 mm to define a low volume.

Both U.S. Pat. No. 5,438,384 and U.S. Pat. No. 5,752,121 disclose an apparatus in which solution is applied using a roller which is coated with the processing solution. The roller is off-set onto the paper surface as the paper is transported on a flat bed. This method is a single-use method and if used once to apply solution it can be described as a “single-application” method. The performance of this type of device is satisfactory in most respects but uniformity of the image is not good enough for commercial use.

U.S. Pat. No. 5,438,384 describes another system of roller application in which a roller picks up solution from a tank and applies it to paper attached to the outside of a drum. This processor does not use tanks which are small enough to allow solution to be discarded. In addition to the difficulties of applying solution uniformly, in the case of the apparatus in U.S. Pat. No. 5,438,384, the solution moves relative to the paper surface due to the movement of the drum and the changing angle of the paper surface. The liquid film is unstable as a result and soon becomes more non-uniform causing unsatisfactory results. In addition the method results in a surface coverage of solution which far exceeds the amount which is used in a replenished process.

U.S. Pat. No. 5,357,305 describes a single use processor which uses a belt with absorbent regions capable of taking up processing solution. The belt is arranged with more than one absorbent region such that a first processing solution and a second processing solution can be independently taken up by different absorbent regions. After take up of processing solution by the absorbent regions the belt moves round to contact the photographic material with a first processing solution and then a second processing solution. The belt is washed in between applications. This processor is potentially a low volume single use processor but it does not apply the same solution repeatedly to the same area of photographic material and it does not carry out the whole cycle process in a single tank. It also requires that the belt material is cleaned in an additional step which has to be carried out automatically for convenience and consumes more water.

U.S. Pat. No. 3,869,288, U.S. Pat. No. 5,477,301, U.S. Pat. No. 5,701,541, U.S. Pat. No. 5,758,223, EP 0984324 and EP 1046953 describe methods of application of processing solutions involving spraying solutions, in some cases using inkjet technology, onto photographic materials to form a static layer which then develops the material. It has been found difficult to apply the processing solutions evenly including near edges of the processed material.

The problem to be solved by the invention is to provide the advantages of single use processing, while avoiding the disadvantages of deep-tank, replenished processing and in a way which avoids the disadvantages of previously disclosed single-use methods. In particular the invention must provide uniform results while only using volumes of solution in relation to the area processed which are similar to or less than the volumes used in replenished processes.

### SUMMARY OF THE INVENTION

According to the present invention there is provided a method of processing chemically sensitive materials in which the material is held on the outer periphery of a drum, the sensitized surface facing outwards, wherein processing solution is applied at least twice from a reservoir to the surface of the material, the total volume of solution applied to the material having a maximum of 300 ml/sqm of material to be processed.

The invention further provides an apparatus for processing chemically sensitive materials including a drum processor on which the material to be processed is mounted, the sensitive surface of the material facing outwards, a supply of processing solution, the volume of said supply being substantially equal to or less than 300 ml/sqm of the material to be processed, and means for repeatedly applying the solution to the surface of the material.

The invention allows the volume of solution, per unit area of material, used in each single use process application to be within a range typical of those volumes used to replenish a conventional deep tank processor. The solution can thus be discarded after use and fresh solution used for subsequent materials to be processed.

Applying the solution at least twice improves the uniformity relative to single application processing. Good uniformity is achieved by the method and apparatus of the invention.

No process control is required since fresh solution is always applied.

The invention allows the use of less stable solutions, e.g. those less well pH buffered, those less well protected against oxidation and so forth.

### BRIEF DESCRIPTION OF THE DRAWINGS

The invention will now be described in more detail with reference to the accompanying drawings in which:

FIG. 1 shows part of a processor according to the present invention;

FIG. 2 is a schematic view of the way in which solution is transferred to the material to be processed;

FIGS. 3, 4, 5 and 6 are graphs illustrated the results of a sensitometry test using the present invention;

FIG. 7 is a graph illustrating the solution laydowns and densities observed during the test;

FIG. 8 is a graph illustrating the densities observed with respect to drum processor speed; and

FIG. 9 shows a further embodiment of the invention.

### DETAILED DESCRIPTION OF THE INVENTION

The description will be directed in particular towards those processor parts relevant to the invention. It will be understood however that the component parts not specifically described may take various forms known in the art.

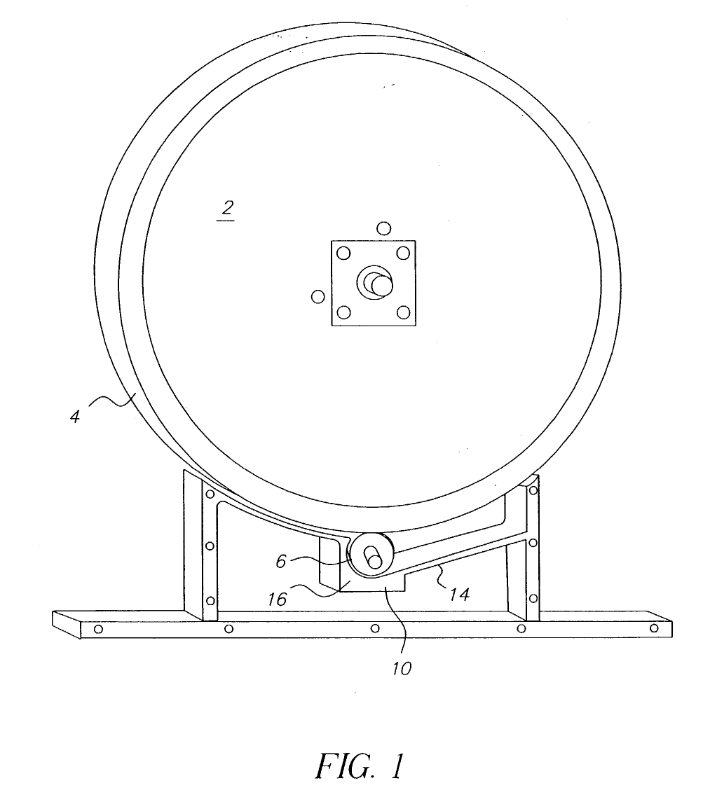

Referring initially to FIG. 1 a drum processor arrangement is shown. The arrangement comprises a drum 2, a roller 6 and a reservoir 10. The surface of the roller may be either textured or smooth. Obviously a textured surface will pick up more solution as it rotates. The drum 2 is rotatable by drive means, not shown. The reservoir 10 is located beneath the drum 2 and holds the processing solution. The strip of material 4 to be processed is located on the surface of the drum, emulsion side facing outwards.

The roller 6 is located on the lower side of the drum 2. The roller 6 is positioned such that there is a narrow gap between the roller 6 and the drum 2. This gap may be up to 0.5 mm wide. Preferably the gap is approximately 400 μM wide. The roller 6 is rotated by drive means (not shown). The roller 6 is located within the reservoir 10. The reservoir may be provided with at least one angled wall 14. The reservoir 10 contains developer or other such processing solution 16 as may be required. The reservoir is small in volume, holding in the range of 30 to 300 ml of solution per square metre of material to be processed.

The paper or other material to be processed may be held onto the surface of the drum by surface attraction of a liquid, by a vacuum, by clamping, by adhesive or by any other known means. The means by which the paper is held onto the surface of the drum is not critical to the invention. The drum 2, and thus the solution 16, may be heated by, for example, re-circulating hot air through the drum.

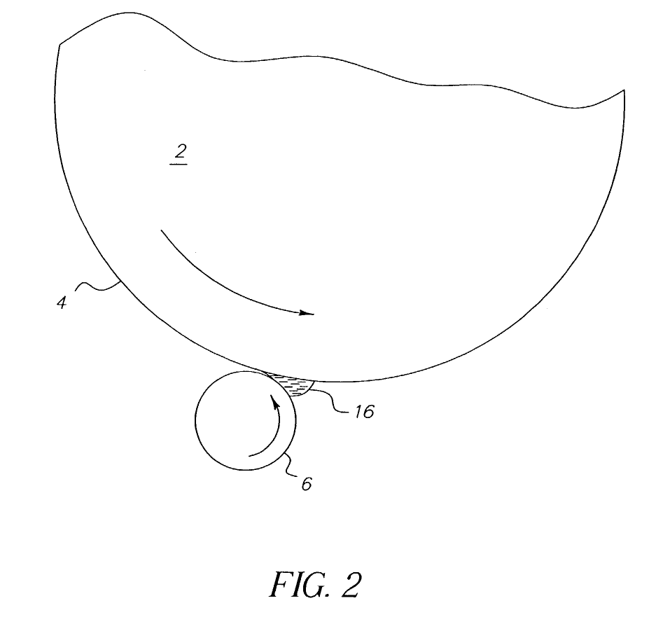

In operation the material 4 to be processed is mounted on the outer surface of the drum 2. Preferably the material covers the whole of the circumference of the drum 2. The material is held in position with respect to the drum as described above. The drum 2 is rotated, anti-clockwise in the embodiment illustrated in FIG. 1. The roller 6 is also rotated anti-clockwise. Due to the relative positioning of the drum and roller the roller 6 effectively rotates backwards relative to the drum 2. The roller 6 rotates within the reservoir 10 and picks up solution on the surface thereof. A bead of solution is formed between the roller 6 and the surface of the material held on the drum. This is shown in more detail in FIG. 2. Formation of the bead is due to the relative speeds of the drum 2 and the roller 6. Processing solution from reservoir 10 is thus supplied to the material 4 as the material passes the roller 6. In the experiment described below a range of speeds between 20 rpm and 100 rpm were tried. The best uniformity was seen with a drum rotation of 76 rpm. Satisfactory results were also achieved with speeds as low as 36 rpm. The diameter of the drum used was 300 mm. It will be obvious to those skilled in the art that the speeds which produce the best results will be dependent on the diameter of the drum used and a number of other factors such as the nature of the surfaces of the paper and application roller, the diameter and speed of rotation of the application roller, and the solution viscosity and interfacial tensions between the liquid and the surfaces contacted by the liquid.

The processing solution remains on the strip of material 4 as the drum 2 rotates. The solution supplied to the surface of the material reacts with the chemistry in the material while the drum is rotating. As the material passes the roller 6 once more fresh solution in the bead is mixed with the solution already on the surface of the material. Thus there is a continuous exchange of chemistry and constant mixing. To ensure the continuation of the formation of the bead the reservoir holds more solution than is used up. Typically three quarters of the volume of solution is used. The remaining solution can be discarded.

The solution is applied at least twice, preferably several times, during the process. This improves uniformity relative to single application processing which can suffer from local instability of the applied solution film of processing solution. This invention allows the volumes of solution used per unit area to be within a range typical of those volumes used to replenish a conventional deep tank processor. Volumes of 30 ml to 300 ml of solution per square metre of material to be processed are typical of volumes used for such replenishment. Solution is discarded after processing of that material and fresh solution used for subsequent materials to be processed.

The rotational speed of the roller dictates the amount of solution that is picked up as it rotates in the reservoir 10. The viscosity of the solution also dictates the amount picked up by the roller, as does the texture of the surface of the roller.

### EXAMPLE

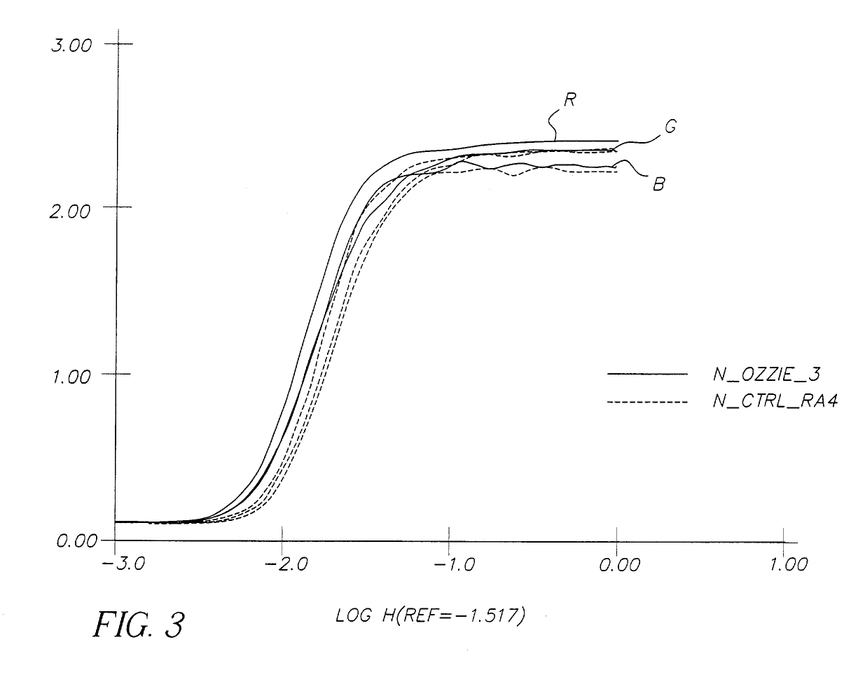

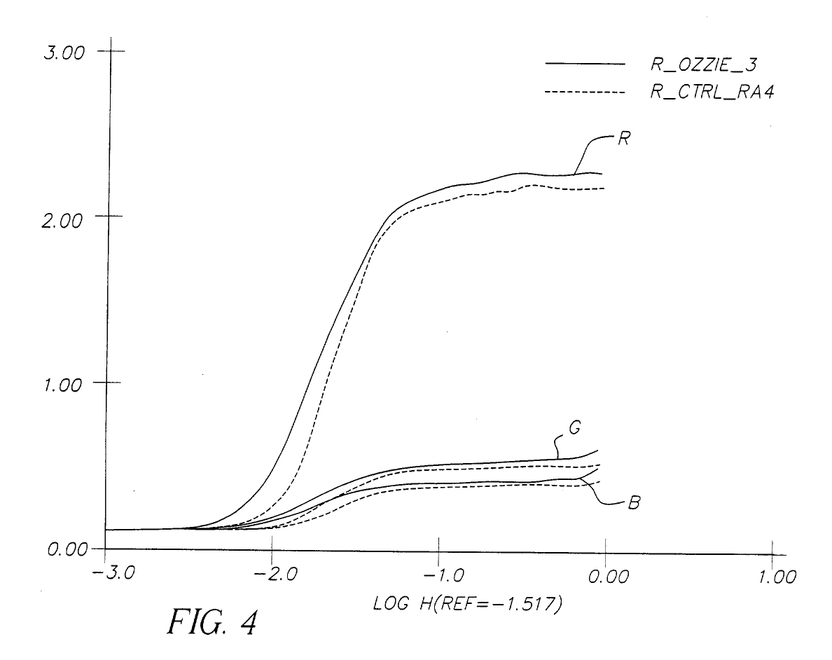

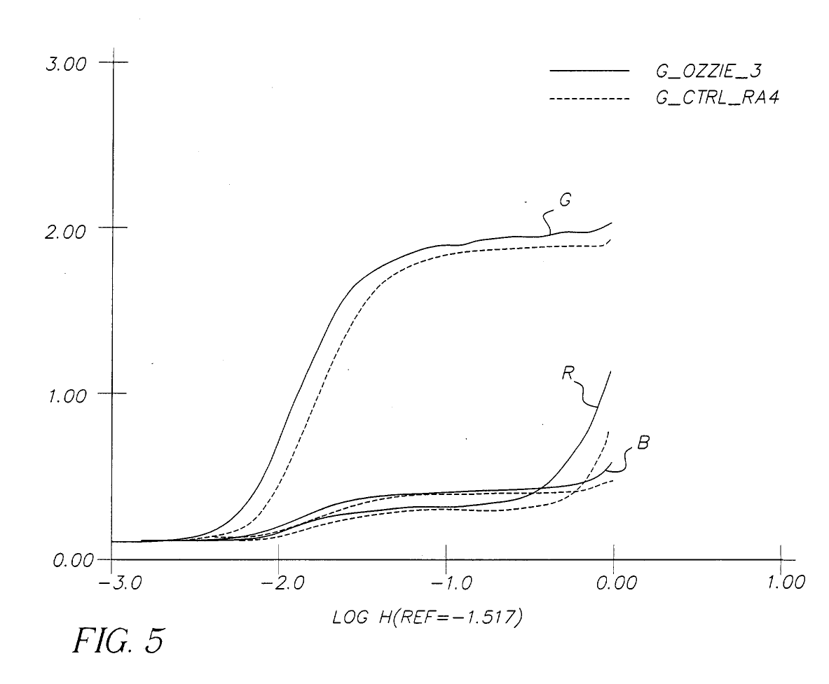

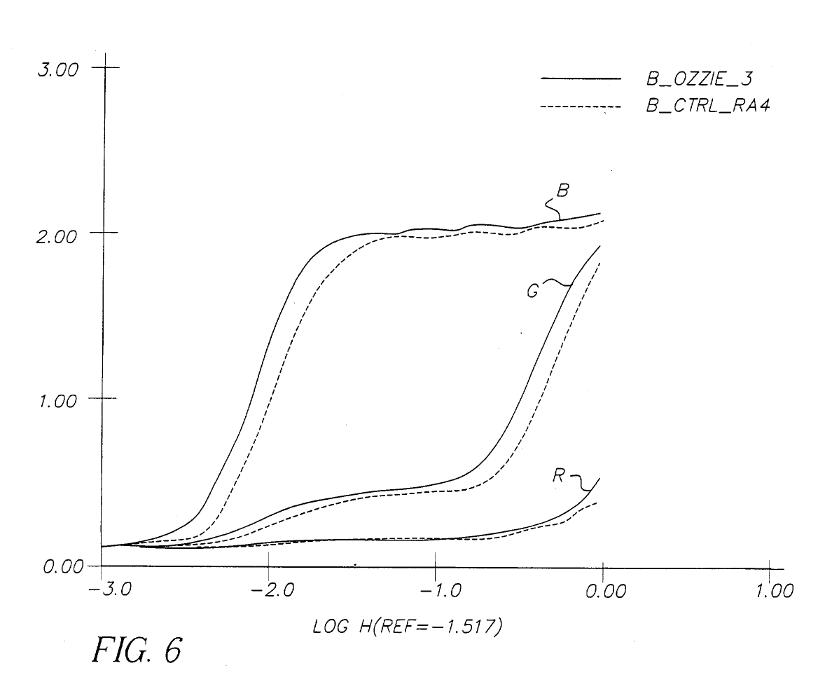

Ektacolor Edge8 photographic paper was exposed to a 21 -step 0.15 ND per step wedge; with red (Wr70), green (Wr99) and blue (Wr98) and neutral (2xcc30R+cc50Y filters) channels; for 0.1 s using a 2850K tungsten light source. The paper was processed in the processor apparatus described above at a temperature of 40C. The development time was 35 s followed by a 30 s stop-bath (10% Acetic Acid solution). The sensitometry achieved is given in FIGS. 3 to 6, compared with a strip processed in a normal roller transport RA4 processor. The gap between the drum (300 mm diameter) and the backward driven roller (25.4 mm diameter) was set at 400 μm. The drum was rotated at 33 rpm and the backward spinning roller was rotated at 520 rpm, reducing to 280 rpm after five seconds of development. The developer was applied at a rate of 115 ml/m². The developer formulation used is given in Table 1.

TABLE 1
Developer Formulation

| | | |
|---|---|---|
| Potassium Carbonate | 33 | g |
| BD-89 | 5 | g |
| CD3 | 10 | g |
| Tween-80 | 0.16 | g |
| PH to 10.6 | | |
| Water to 1 liter | | |

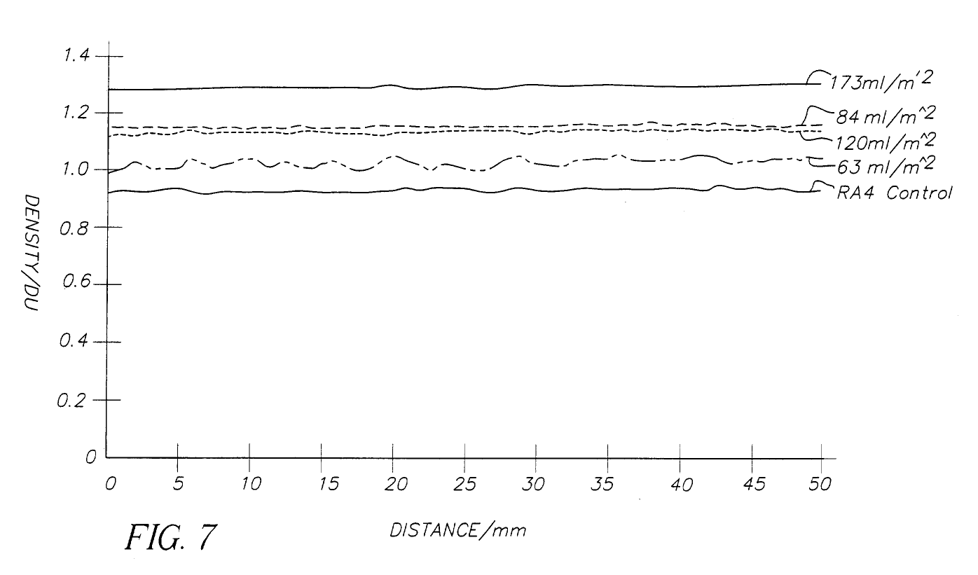

A patch of Ektacolor Edge8 paper was exposed to a neutral density of approximately 1 DU. Developer was also applied at a number of levels of developer usage and the cross drum uniformity was assessed by measurement of the cyan layer density uniformity. Table 2 and FIG. 7 show the developer laydowns used and the average cyan densities, with standard deviations, which were observed; compared with a uniform exposure processed through a normal roller transport RA4 processor. Good uniformity was observed at all levels above 63 ml/m².

TABLE 2
Developer Uniformity at Various Laydowns

| Developer Laydown | | |
|---|---|---|
| (ml/m²) | Average Density (DU) | Standard Deviation (DU) |
| 63 | 1.01 | 0.013 |
| 84 | 1.14 | 0.003 |
| 120 | 1.12 | 0.003 |
| 173 | 1.28 | 0.002 |
| Standard RA4 Control | 0.92 | 0.003 |

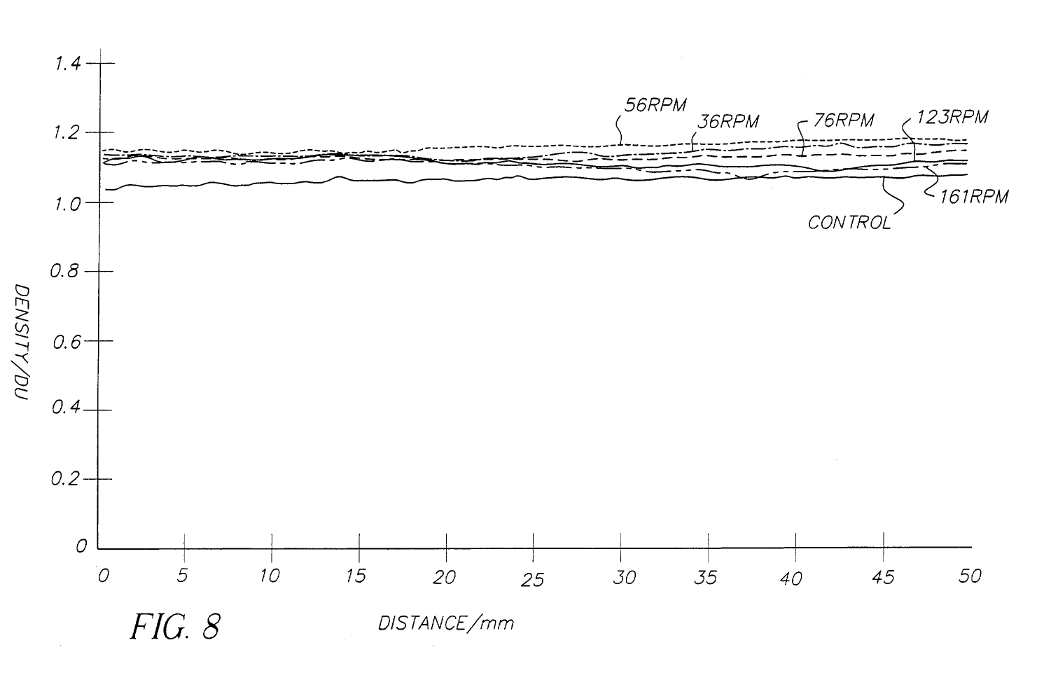

Ektacolor Edge8 paper was also exposed to a neutral density of approximately 1 DU and the rotational speed of the drum was varied. Developer was applied at a usage rate of 115 ml/m² and the cross drum uniformity was assessed by measurement of the cyan layer density uniformity. Table 3 and FIG. 8 show the drum speeds used and the average cyan densities, with standard deviations, which were observed; compared with a uniform exposure processed through a normal roller transport RA4 processor. The best uniformity was seen with a drum rotating at 76 rpm.

TABLE 3
Developer Uniformity with respect to Drum Speed

| | Drum linear | | |
|---|---|---|---|
| | Surface | Average | Standard |
| Drum Speed (rpm) | Velocity (ms⁻¹) | Density (DU) | Deviation (DU) |
| 16 | 0.25 | 1.09 | 0.025 |
| 36 | 0.57 | 1.12 | 0.009 |
| 56 | 0.88 | 1.14 | 0.007 |
| 76 | 1.20 | 1.10 | 0.003 |
| 123 | 1.93 | 1.10 | 0.018 |
| Standard RA4 Control | | 1.04 | 0.004 |

The method described may be used for one step only in the processing of a material or for each of the steps and different solutions. If the method of the invention is used for only, say, the development step the subsequent steps may be performed in conventional processing apparatus.

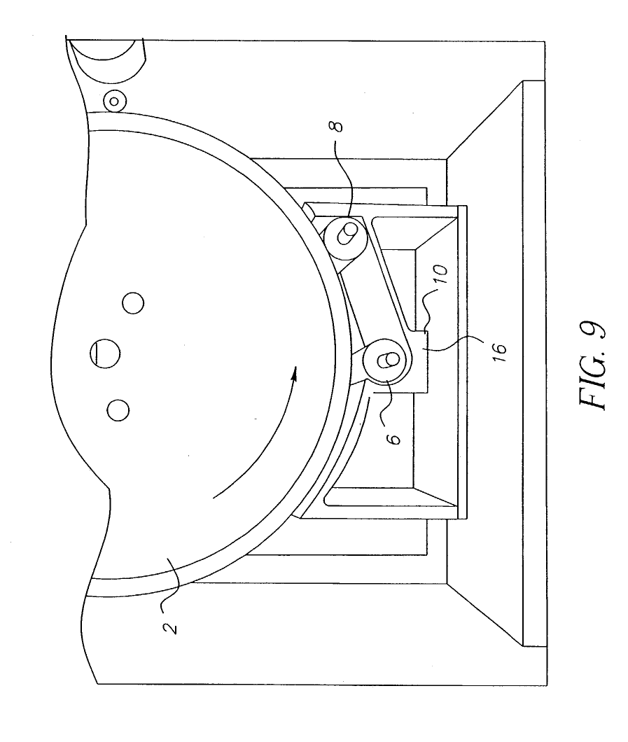

FIG. 9 illustrates a further embodiment of the invention. The embodiment is similar to that illustrated in FIG. 1 but has an additional roller 8. The drum 2, roller 6 and reservoir 10 are the same as illustrated in FIG. 1 and will not be described again.

Roller 8 is positioned farther along the outer circumference of the drum 2 from roller 6, in the direction of rotation of the drum, and at a position vertically higher than roller 6. However the roller 8 must be at the lower part of the drum 2. The roller 8 is positioned such that there is no gap between the roller and the drum 2. Roller 8 thus acts as a squeegee roller and removes any solution not absorbed by the material at this point. The roller must be positioned at the lower part of the drum so that any solution squeegeed out of the material does not run back along the surface of the material but drops from the surface. Any solution removed by the roller 8 returns to the reservoir and is reapplied by the roller 6.

In this embodiment the relative position of the roller 6 and squeegee roller 8 dictates the fraction of time for which the material 4 is in contact with the volume of processing solution outside of the swollen layers of the material. Less volume of solution is required for formation of the bead of solution. For example, if the squeegee roller is placed ⅛ of the circumference from the roller 6 the volume required is eight times less than that required if no squeegee roller is used. The solution is thus applied to a portion of the material and the majority of it subsequently removed so that the solution is in contact with the film for a fraction of the processing time. The squeegee roller 8 allows wetting of a given area with less solution.

It will be understood by those skilled in the art that the rollers described in both embodiments are examples only of application and removal means for the solution. The solution may be applied to the material by any suitable means. Further examples include spray means or hopper means. Further examples of removal means may be a flexible blade, such as is made of rubber or plastics material. Alternatively the solution may be removed from the surface of the material by an air knife or a deformable object such as a fluid filled tubular sack.

The invention has been described with reference to colour paper. However it will be understood that the invention is applicable to colour and black and white paper and film and to graphics. Furthermore the invention is not limited to photographic material but can be used with any chemically sensitive material that needs to be treated.

Parts List

2. Drum

4. strip of material

6. Roller

8. roller

10. reservoir

14. angled wall

16. processing solution

What is claimed is:

1. A method of processing chemically sensitive materials in which the material is held on the outer periphery of a drum, the sensitized surface facing outwards, wherein processing solution is applied at least twice from a reservoir to the surface of the material, the total volume of solution applied to the material having a maximum of 300 ml/sqm of material to be processed.

2. A method as claimed in claim 1 wherein the solution is applied to the material by means of a roller.

3. A method as claimed in claim 1 wherein the solution is removed from the material such that the solution is in contact with the material for only a fraction of the processing time.

4. A method as claimed in claim 3 wherein the solution is removed from the material by means of a roller.

5. A method as claimed in claim 1, being a method for processing photographic material.

6. A method as claimed in claim 5 wherein the processing uses a redox amplification or intensification process.

7. A method according to claim 1 wherein the drum is rotated at a speed in the range of 20 rpm to 100 rpm.

8. Apparatus for processing chemically sensitive materials including a drum processor on which the material to be processed is mounted, the sensitive surface of the material facing outwards, a supply of processing solution, the volume of said supply being substantially equal to or less than 300 ml/sqm of the material to be processed, and means for repeatedly applying the solution to the surface of the material.

9 Apparatus as claimed in claim 8 wherein the means for repeatedly applying the solution to the surface of the material comprises a driven roller.

10. Apparatus as claimed in claim 9 wherein the drum and the driven roller are positioned to have a gap of up to 0.5 mm between them.

11. Apparatus as claimed in claim 8 wherein the means for repeatedly applying the solution to the surface of the material comprises spray means.

12. Apparatus as claimed in claim 8 wherein the means for repeatedly applying the solution to the surface of the material comprises hopper means.

13. Apparatus as claimed in claim 8 including removal means for removing solution from the surface of the material such that the solution is in contact with the material for only a fraction of the processing time.

14. Apparatus as claimed in claim 13 wherein the removal means comprises a roller.

15. Apparatus as claimed in claim 13 wherein the removal means comprises flexible blade means.

16. Apparatus as claimed in claim 13 wherein the removal means comprises an air knife.
